(19) United States
(12) Patent Application Publication
(10) Pub. No.: US 2023/0003573 A1
(43) Pub. Date: Jan. 5, 2023

(54) KITCHEN SCALE

(71) Applicant: Shenzhen Shine Industrial Co., Ltd., Shenzhen (CN)

(72) Inventor: Xinqiang Xu, Shenzhen (CN)

(21) Appl. No.: 17/508,897

(22) Filed: Oct. 22, 2021

(30) Foreign Application Priority Data
Jul. 1, 2021 (CN) 202110749230.8

(51) Int. Cl. G01G 23/18; G01G 21/22; G01G 19/00; H04R 1/02

(52) U.S. Cl. CPC G01G 23/18; G01G 21/22; G01G 19/00; H04R 1/028

(57) ABSTRACT

A kitchen scale, including a scale body, a magnetic attraction part arranged in the scale body, a radio module arranged in the scale body, at least one button arranged on a surface of the scale body, and a speaker arranged in the scale body. It is convenient to place the kitchen scale, and the kitchen scale is unnecessarily placed on any countertop and does not occupy any storage space.

### CROSS REFERENCE TO RELATED APPLICATIONS

This application claims priority to Chinese Patent Application No. 2021107492308, filed on Jul. 1, 2021, entitled “KITCHEN SCALE”, and the entire contents of which is incorporated herein by reference.

### TECHNICAL FIELD

The present disclosure relates to a weighing appliance, in particular, to a kitchen scale.

### BACKGROUND

With the improvement of living standards, people have higher and higher requirements for the quality of life. As one of the kitchen supplies, an electronic kitchen scale is a good helper for family life, especially suitable for using in and decorating a modern kitchen. The electronic kitchen scale may help people to accurately weigh the food and is more and more popular with many modern families, especially in developed countries, such as European countries and the United States.

At present, the storage way of the kitchen scale on the market is to hang the kitchen scale on the wall with a hook, or is that consumers themselves put the scale in a storage cabinet. The way of hanging the kitchen scale on the wall at a fixed position is not flexible, and requires a corresponding hook to cooperate. Furthermore, some hooks are not quite flexible in a process of picking up a hung object, and the hung object must be moved in a specific direction, otherwise it may be hooked by the hooks. When the object is to be put back after use, it is necessary to carefully align the hanging position of the objects with the hooks. Storing the kitchen scale in the cabinet causes it inconvenient to access the kitchen scale, and the kitchen scale occupies valuable storage space.

In addition, the current kitchen scales on the market can be used for weighing only, and only have a relatively single weighing function. Moreover, some consumers have the habits of listening to some audio programs while working in the kitchen. If a special radio is used, the special radio or a mobile phone is needed to make audio programs play. Whether the audio programs are played with a special radio or a mobile phone, because there is often oil or water stains on many countertops in the kitchen, the placement of the radio or the mobile phone becomes a problem. What's more, people often get oily or dirty hands when working in the kitchen, which causes it inconvenient to operate on a radio or a mobile phone with relatively sophisticated structures and small buttons.

### SUMMARY

Based on this, it is necessary to provide a new kitchen scale. In addition to providing the weighing function, the kitchen scale also provides a function of playing audio programs, and it is also convenient to place it. The kitchen scale is unnecessarily to be placed on any countertop or does not need to occupy storage space, and it is not easily polluted by oil or water stains.

A kitchen scale, includes a scale body, a magnetic attraction part arranged in the scale body, a radio module arranged in the scale body, at least one button arranged on a surface of the scale body, and a speaker arranged in the scale body.

The details of one or more embodiments of the present application are set forth in the following drawings and description. Other features, purposes and advantages of the present application will become apparent from the description, drawings, and claims.

### BRIEF DESCRIPTION OF THE DRAWINGS

To illustrate the embodiments of the present disclosure or the technical solutions in the prior art more clearly, the accompanying drawings for describing the embodiments or the prior art are introduced briefly hereafter. Apparently, the accompanying drawings described hereafter are only some embodiments of the present disclosure and based on the accompanying drawings, and other drawings may be obtained by those skilled in the art without creative efforts.

FIG. 1 is a schematic top view of an embodiment of a kitchen scale;

FIG. 2 is a sectional view of an embodiment of the kitchen scale along a line A-A in FIG. 1;

FIG. 3 is a side view of an embodiment of the kitchen scale in FIG. 1;

FIG. 4 is a schematic bottom view of an embodiment of the kitchen scale in FIG. 1.

### DESCRIPTION OF REFERENCE NUMERALS

scale body 100; magnetic attracting part 1; radio module 2; first scroll button 3; second scroll button 4; speaker 5;

### DETAILED DESCRIPTION

In order to make the present disclosure to be understood, the present disclosure will be described in further details with the accompanying drawings. The preferred embodiments of the present disclosure are recited in the drawings. But the present disclosure may be realized in various forms, and not limited to the specific embodiments described herein. Conversely, the specific embodiments provided herein are merely for the purpose of making the present disclosure to be understood more clearly and comprehensively.

All technologies and scientific terminologies used herein have the same ordinary meanings understood by those skilled in the art unless otherwise indicated. The terminologies herein are merely used to describe the specific embodiments of the present disclosure, but not intended to limit the present disclosure. The terms “or/and” used herein may include any combination or all combinations of any one or multiple corresponding items.

In the following description, a lot of specific details are given in order to provide a more thorough understanding of this application. However, it is obvious to those skilled in the art that this application can be implemented without one or more of these details. In other examples, in order to avoid confusion with this application, some technical features known in the art are not described.

It should be understood that the present application can be implemented in different forms and should not be construed as being limited to the embodiments presented here. On the contrary, the provision of these embodiments will make the disclosure thorough and complete, and will fully convey the scope of the present application to those skilled in the art. In the drawings, the sizes and relative sizes of layers and regions may be exaggerated for clarity. The same reference numerals denote the same elements throughout.

It should be understood that when an element or layer is referred to as being “on”, “adjacent to”, “connected to” or “coupled to” other elements or layers, it may be directly on, adjacent to, connected to, or coupled to other elements or layers, or intervening elements or layers may be provided. In contrast, when an element is referred to as being “directly on”, “directly adjacent to”, “directly connected to” or “directly coupled to” other elements or layers, no intervening elements or layers are provided. It should be understood that although the terms first, second, third, etc. may be used to describe various elements, components, regions, layers and/or sections, these elements, components, regions, layers and/or sections should not be limited to these terms. These terms are only used to distinguish one element, component, region, layer or section from another element, component, region, layer or section. Therefore, without departing from the teachings of the present application, the first element, first component, first region, first layer or first section discussed below may be represented as a second element, second component, second region, second layer or second section.

Spatial relation terms such as “under”, “below”, “lower”, “beneath”, “on”, “above”, etc. used hereafter for the convenience of description the relationship between one element or feature and other elements or features shown in the figures. It should be understood that in addition to the orientations shown in the figures, the spatial relationship terms are intended to include different orientations of devices in use and operation. For example, if the device in the drawings is turned over, then elements or features described as “below”, “under”, or “beneath” other elements will be oriented “above” the other elements or features. Therefore, the exemplary terms “below” and “under” may include both an orientation of above and below. The device may be otherwise oriented (rotated by 90 degrees or other orientations) and the terms of spatial description used herein are interpreted accordingly.

The purpose of the terms used herein is only to describe specific embodiments and not as a limitation of the present application. When used herein, the singular forms of “a”, “an” and “the/the” are also intended to include plural forms, unless the context clearly indicates otherwise. It should also be understood that the terms “comprise” and/or “include”, when used in this specification, determine the existence of the feature, integer, step, operation, element and/or component, but do not exclude existence or addition of one or more other features, integers, steps, operations, elements, components, and/or groups. As used herein, the term “and/or” includes any one of and all combinations of related listed items.

The embodiment of the present application provides a kitchen scale, including a scale body, a magnetic attraction part arranged in the scale body, a radio module arranged in the scale body, at least one button arranged on the surface of the scale body, and a speaker arranged in the scale body. For the details, please refer to FIG. 1.

FIG. 1 shows an embodiment of a kitchen scale, including the scale body 100. In this embodiment, the scale body is in a shape of a flat plate.

The kitchen scale further includes the magnetic attraction part 1 arranged in the scale body 100 and configured to enable the scale body to be adsorbed on a metal surface, such as a surface of a refrigerator. Compared with a hook arranged on the scale body 100 or a structure configured to match the hook, the magnetic attraction part 1 makes it much more convenient and freer to use the kitchen scale, and sufficient safety and reliability may always be achieved. In particular, the magnetically fixing method enables the kitchen scale to be adhered to a surface of an object, which may avoid swings and reduce vibration effects, so that a user can easily operate the kitchen scale with one hand. A magnet or a magnetic block in the magnetic attraction part 1 may be selected to fit or match a shape of the scale body 100, so that the arrangement of the magnetic block will not affect the structure and appearance of the scale body 100. The magnetic attraction solution has obvious convenience in use. If the kitchen scale will be used to weigh objects, it may be taken off from a refrigerator and any other appliances conveniently, without paying attention to the move direction of the kitchen scale. After being used, the kitchen scale may be just put away, without taking care to align the hanging part of the kitchen scale with the hook.

The radio module 2 is arranged inside the scale body 100, and specifically may be arranged at a position close to the edge of the scale body 100, which makes it convenient to receive broadcast signals.

As an embodiment, the radio module 2 may include an antenna (not shown), a high frequency amplifier (not shown), a mixer (not shown), an intermediate frequency amplifier (not shown), and a power amplifier (not shown) and a speaker (not shown). The antenna, the high-frequency amplifier, the mixer, the intermediate frequency amplifier, the power amplifier, and the speaker are connected in sequence. A digital phase-locked loop circuit (not shown) may also be provided in the scale body 100. The data output end of the phase-locked loop circuit is connected to the control terminal of the oscillator in the mixer, and a stereo indicator terminal of the mixer, which outputs intermediate frequency and amplitude, is connected to a data input end of the phase-locked loop circuit in the scale body 100. A clock signal line and a chip select signal line are also connected between the scale body 100 and the mixer. In the present embodiment, the kitchen scale with radio function of the present disclosure is implemented through system integration based on two technical solutions, one of which is the technical solution of a scale, and the other of which is the technical solution of a wireless digital tuning radio. In the wireless digital tuning radio, the signals received by the antenna is high-amplified, mixed, mid-amplified, and power-amplified, and finally the audio signals are outputted through the speaker, and the scale body 100 may be configured to realize a selection and a control of received bands of the wireless digital tuning radio.

In an embodiment, the mixer may function as a combination component of the scale body 100 and the wireless digital tuning radio. The mixer may achieve an output of a fixed difference frequency, i.e., an intermediate frequency of 10.7 MHz, by adjusting frequency of the oscillator thereof, and then the signals processed by the intermediate frequency amplification and the power amplification are outputted to the speaker (or earphone). The present disclosure may realize a control of band selection (channel selection) by configuring and using a scale body, and control the value of the digital phase-locked loop circuit (PLL) by means of software, so that the difference frequency reaches 10.7 MHz. For a channel selection performed by an automatic search, the scale body controls the value of the PLL according to the output signal fed back by the mixer by means of the internal software, to change the oscillation frequency of the voltage-controlled oscillator in the mixer, so that the intermediate frequency output maintains 10.7 MHz stably.

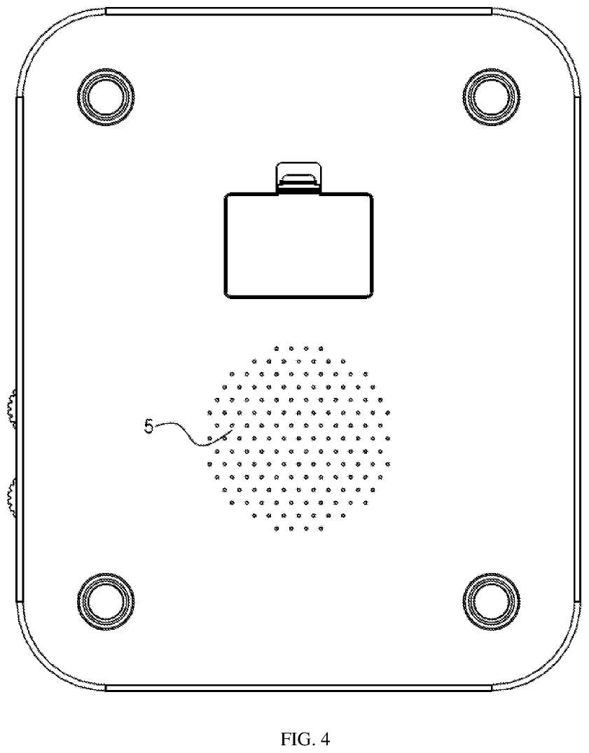

The kitchen scale also includes at least one button arranged on the surface of the scale body 100. In this embodiment, the at least one button are two buttons, namely a first scroll button 3 and a second scroll button 4 in the figure, which are arranged at the sides of the scale body 100. For the details, please refer to FIG. 3. FIG. 3 is a side view of the kitchen scale of this embodiment. The scroll buttons are arranged at the side of the scale body 100 to allow the user to conveniently adjust the scroll buttons when the kitchen scale is placed, for example, on a refrigerator. In another embodiment, the at least one button may be a touch button, and the number of the touch buttons may also be two. The position where the touch buttons are arranged may also be the upper surface or the side of the scale body, and it is not limited herein.

Further refer to FIG. 4, the kitchen scale further includes a speaker 5 arranged in the scale body 100. When the upper surface of the scale body 100 is adhered to, such as a surface of a refrigerator, the bottom of the scale body 100 is in an unobstructed state, so that the sound waves from the speaker 5 may be well transmitted. Even if the bottom surface of the scale body 100 is adhered to, such as a surface of a refrigerator, since the scale body 100 generally has several supporting feet (not shown), a certain gap will be left between the scale body 100 and the surface on which the scale body is adhered to, therefore the sound of the speaker 5 will not be affected.

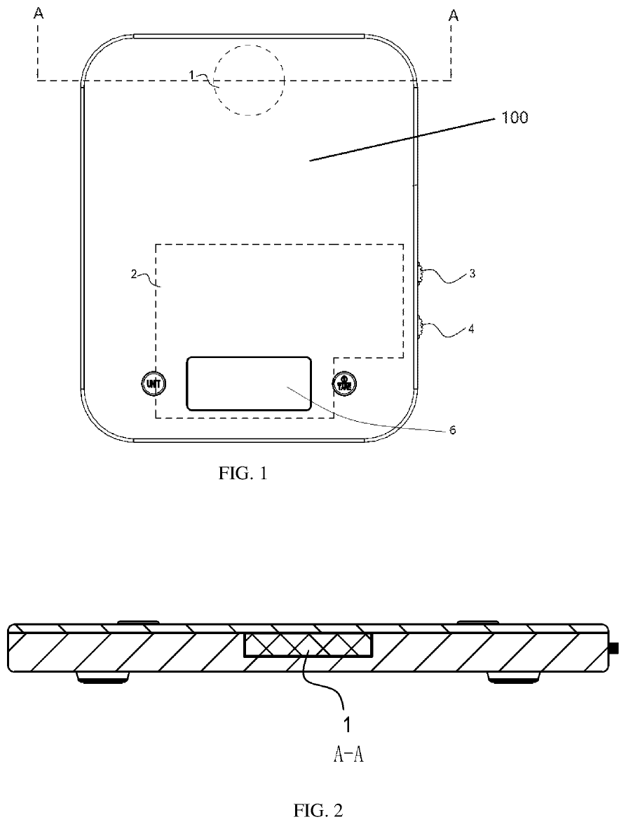

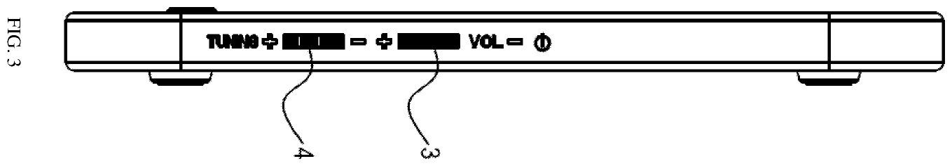

Further refer to FIG. 2. FIG. 2 is a sectional view of the kitchen scale along the line A-A in FIG. 1, which shows the magnetic attraction portion 1 fixed in the scale body 100.

In an embodiment, the magnetic attraction part 1 may be fixed in the scale body 100 by double-sided adhesive bonding.

In an embodiment, the magnetic attraction part 1 may be fixed in the scale body 100 by screws.

In an embodiment, the magnetic attraction part 1 may be fixed in the scale body 100 by welding.

In an embodiment, the first scroll button 3 is a switch and volume adjustment button of the radio module 2. For example, when the first scroll button 3 rotates to a certain position, it turns on the radio module 2, and when it continues to rotate, the volume is gradually increased.

In an embodiment, the second scroll button 4 is a frequency modulation button of the radio module 2, and the function of frequency modulation is realized by rotating the second scroll button 4.

In an embodiment, the kitchen scale further includes a display screen 6 arranged on an upper surface of the scale body 100 and configured to display weight readings and radio channel information.

In an embodiment, the present application also provides a kitchen scale, including the scale body 100.

The kitchen scale further includes the magnetic attraction part 1 arranged in the scale body 100. The magnetic attraction part 1 is fixed in the scale body 100 by double-sided adhesive bonding. Or the magnetic attraction part 1 is fixed in the scale body 100 by screws. Or the magnetic attraction part 1 is fixed in the scale body 100 by welding. The radio module 2 is arranged in the scale body 100. At least two scroll buttons (3, 4), namely the first scroll button 3 and the second scroll button 4 are arranged on the surface of the scale body 100, and at least one button is a scroll button. The speaker 5 is arranged in the scale body 100.

The first scroll button 3 is the switch and volume adjustment button of the radio module 2.

The second scroll button 4 is a frequency modulation button of the radio module 2.

The kitchen scale further includes the display screen 6 arranged on the upper surface of the scale body 100 and configured to display the weight readings and the radio channel information.

It is convenient to place the above kitchen scale, and the kitchen scale is unnecessarily placed on any countertop and does not occupy any storage space. The user may adhere the kitchen scale to the refrigerator easily, so it is not easy to be polluted by oil or water stains. Moreover, the above kitchen scale also provides the functions of a radio, the user may have his/her favorite programs to be played while working in the kitchen, and the operation is also very convenient.

What's more, the above kitchen scale may be designed as an integrated plate, which makes cleaning is also more convenient.

All technical features in the embodiments can be arbitrarily combined. For purpose of simplifying the description, not all arbitrary combinations of the technical features in the embodiments illustrated above are described. However, as long as such combinations of the technical features are not contradictory, they should be considered to be within the scope of the specification of the disclosure.

The above embodiments are merely illustrations of several implementations of the disclosure, and the description thereof is more specific and detailed, but should not be deemed as limitations to the scope of the present disclosure. It should be noted that, for those skilled in the art, various deformations and improvements can be made without departing from the concepts of the present disclosure. All these deformations and improvements are within the protection scope of the present disclosure. Therefore, the protection scope of the present disclosure is defined by the appended claims.

What is claimed is:

1. A kitchen scale, comprising:
a scale body;
a magnetic attraction part arranged in the scale body;
a radio module arranged in the scale body;
at least one button arranged on a surface of the scale body; and
a speaker arranged in the scale body.

2. The kitchen scale of claim 1, wherein the at least one button is a scroll button.

3. The kitchen scale of claim 1, wherein the at least one button is a touch button.

4. The kitchen scale of claim 1, wherein the at least one button are two buttons.

5. The kitchen scale of claim 1, wherein the magnetic attraction part is fixed in the scale body by double-sided adhesive bonding.

6. The kitchen scale of claim 1, wherein the magnetic attraction part is fixed in the scale body by screws.

7. The kitchen scale of claim 1, wherein the magnetic attraction part is fixed in the scale body by welding.

8. The kitchen scale of claim 4, wherein one of the two buttons is a switch and volume adjustment button of the radio module.

9. The kitchen scale of claim 8, wherein another of the two buttons is a frequency modulation button of the radio module.

10. The kitchen scale of claim 1, further comprising a display screen arranged on an upper surface of the scale body and configured to display weight readings and radio channel information.
